(19) United States
(12) Patent Application Publication
(10) Pub. No.: US 2013/0111008 A1
(43) Pub. Date: May 2, 2013

(54) NETWORK SERVICE MONITORING AT EDGE NETWORK DEVICE

(71) Applicants: Chuck A. Black, Rocklin, CA (US); Daniel E. Ford, Granite Bay, CA (US)

(72) Inventors: Chuck A. Black, Rocklin, CA (US); Daniel E. Ford, Granite Bay, CA (US)

(21) Appl. No.: 13/284,530

(22) Filed: Oct. 28, 2011

(51) Int. Cl. G06F 15/16

(52) U.S. Cl. 709/224

(57) ABSTRACT

An edge network device may monitor a network service that is provided at a network service device. Information related to the monitored network service may be temporarily stored at the edge network device and transmitted to a remote network device.

### BACKGROUND

Networks typically have operating therein multiple devices including an end user device and a network services device that provides services to the end user device. The end user device may access the network services device through an edge network device. The network may further include an administrative server that administers to the devices in the network.

### DRAWINGS

FIG. 1. is an example diagram of a system environment, in accordance with an example embodiment of the present disclosure.

FIG. 2 is an example diagram of a probe class hierarchy in accordance with an example embodiment of the present disclosure.

FIG. 3 is an example diagram of a measurement class hierarchy, in accordance with an example embodiment of the present disclosure.

FIG. 4 is an example flow diagram of a method for monitoring a network service, in accordance with an example embodiment of the present disclosure.

### DETAILED DESCRIPTION

Network management tools may be used to monitor network services in the network. Network services may include web servers, mail servers, name servers, etc. Monitoring may take place near where the network service is being provided and may provide information regarding the service itself. However, where the monitoring is located near where the service is provided, information cannot be obtained regarding an end user's access to the service.

### Overview

Monitoring of network services near where the end user device resides provides useful information regarding the end user's access to network services. As discussed herein, an edge network device may include a monitoring module that may monitor a network service provided remote from the edge network device. In addition, the edge network device may temporarily store in storage information related to the monitoring of the network service. The information related to the monitored network service may be provided to a remote network device.

The edge network device may alternatively include a configuration module. The configuration module may provide an interface that may be accessed by another device in the network, for example, an end user device, and administrative device, etc., and may facilitate entry of one or more parameters that may be used to identify and facilitate monitoring of one or more network services at a network services device.

### System Environment

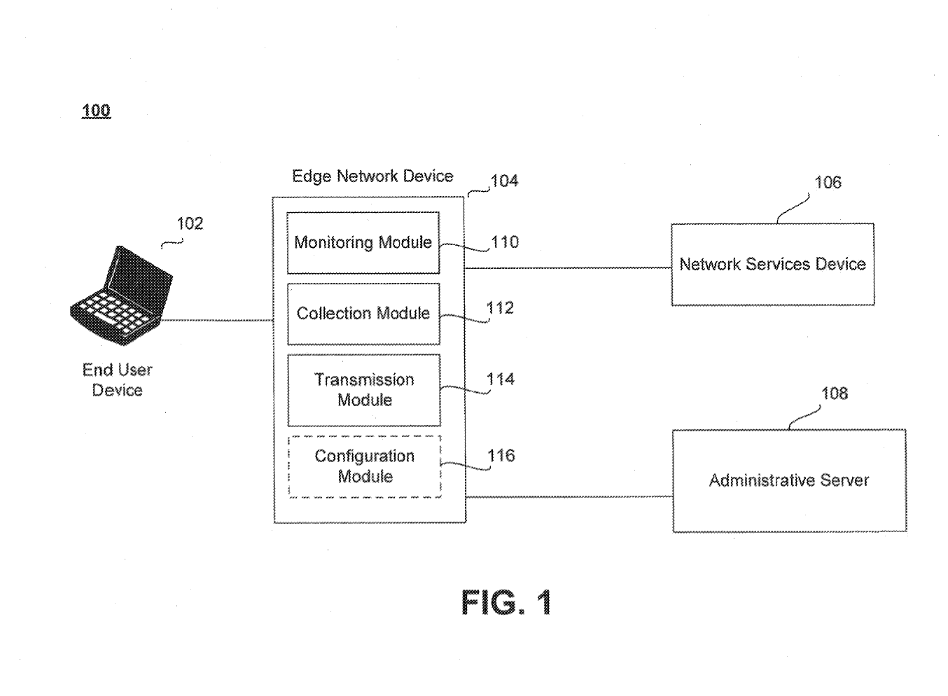

FIG. 1 is an example system environment 100 in accordance with an example embodiment of the present disclosure. As shown in FIG. 1, system environment 100 includes end user device 102, edge network device 104, network services device 106 and administrative server 108. The devices depicted in FIG. 1 operate in a network wherein the network may be implemented as one or more of any wide area network (WAN) or local area network (LAN) in accordance with the functionality as discussed herein. For example, one or more networks may be implemented as any wired or wireless network, including an enterprise network, Global System for Mobile Communication (GSM) network, wideband code division multiple access (WCDMA), general packet radio services (GPRS), personal communication services (PCS), worldwide interoperability for microwave access (WiMAX), local area network (LAN), WAN, for example, the Internet, etc. It may be appreciated additional devices may be incorporated in system environment 100.

Edge network device 104 and administrative server 108 may be implemented through any suitable combinations of software including machine readable instructions, firmware, including machine readable instructions, and/or hardware. Edge network device 104 and administrative server 108 may include primary and secondary memory that may be computer-readable mediums configurable to store machine readable instructions, executable by a processor, as discussed herein. Primary and/or secondary memory may further be configurable to receive an installation pack from an external memory, for example, a portable computer-readable medium, for example, a Compact Disc/Digital Video Disc, etc. Edge network device 104 and administrative server 108 may include secondary memory that may be implemented within the device and/or may be implemented as external data storage.

End user device 102 may be implemented as any computing device, for example, a laptop computer, a desktop computer, a mobile computing device, a personal digital assistant (PDA), etc. End user device 102 is communicably linked to edge network device 104 and may access the network through edge network device 104.

Edge network device 104 may be implemented as, for example, an edge network switch, an edge network router, an edge controller, a wireless edge access point, a wireless edge router, etc. Edge network device 104 is considered an edge network device as it located on the edge of the network, namely, it is directly communicably linked to an end user device 102 where there is no intermediate computing device that facilitates communication between the edge network device and the end user device.

Edge network device 104 may be directly communicably linked to end user device 102. Edge network device 104 may be the point of entry for end user device 102 into the network. Edge network device 104 may be communicably linked to network services device 106. It may be appreciated that additional network devices may reside in the communication path between edge network device 104 and network services device 106, for example, one or more routers, switches, etc. Edge network device 104 may be communicably linked to administrative server 108. It may be appreciated that additional network devices may reside in the communication path between edge network device 104 and administrative server 108, for example routers, switches, etc.

As discussed more fully below, in addition to components to facilitate networking operation, the edge network device 104 may include monitoring module 110, collection module 112, transmission module 114 and optionally configuration module 116. Monitoring Module 110, collection module 112, transmission module and configuration module 116 may be implemented in software in the form of computer-executable instructions, stored in a computer-readable storage medium that, when executed by a processor, realize the functionality as discussed herein.

Network services device 106 may be implemented as one or more computing devices co-located or located remote from each other. Network services device 106 may be located any wherein the network, including the edge of the network, a data center, a campus, a branch, etc. Network services device may be implemented as one more devices including name server, for example, dynamic host configuration protocol (DHCP) server, domain name system (DNS), web server, internet service provider server, electronic mail server, printer server, remote authentication dial-in user service (RADIUS) server, an Oracle database, SAP, Iron Mountain PC Backup Server, Norton Anti-Virus Server, lightweight directory access protocol (LDAP), etc. Network services device 106 may be communicably linked either directly or through one or more intermediary network devices, for example, routers switches, etc., to edge network device 104. It may be appreciated that any service that is provided in a network may be monitored in accordance with the features discussed herein.

Administrative server 108 may be implemented as, for example, a server computing device for administering the network environment 100.

### Monitoring Module

Edge network device 104 includes monitoring module 110. The monitoring module 110 may perform functionality that monitors access to network services device 106 by obtaining information related to availability and response time. Monitoring module may employ monitoring tools, for example one or more probes, for monitoring network services at network services device 106. For example, products provided by Openview Internet Services and SiteScope may be employed to monitor network services at network services device 106. These services may include, for example:

Internet control message protocol (ICMP)—the ICMP probe may perform a simple ping to a destination in order to determine if the service's host is reachable;

Dynamic host configuration protocol (DHCP)—the DHCP probe may attempt to get an IP address from a DCHP server, and then may release the IP address immediately thereafter. This probe may verify that an IP address can be obtained from the DCHP server;

Domain name system (DNS)—the DNS probe may perform a lookup on a configured hostname and check the returned IP address to verify that what is returned is the expected value. This probe may verify that a hostname can be resolved to an IP address;

Internet—the Internet probe may attempt to retrieve a configured external web page. This probe may verify that users can get access to the Internet;

Internal web server—the Internal web server probe may attempt to retrieve a configured internal (within the intranet) webpage. This probe may verify that the specified internal web server is running and returning pages when requested;

Mail—the Mail probe may attempt to send mail to, and receive mail from, a mail server. This probe may verify that email messages may be sent and received; and

RADIUS—the RADIUS probe may attempt to authenticate a user. This probe may verify that network access control is running and users can gain access to the network.

It may be appreciated that additional probes may be provided that test access to other network services, for example, a printer server, etc.

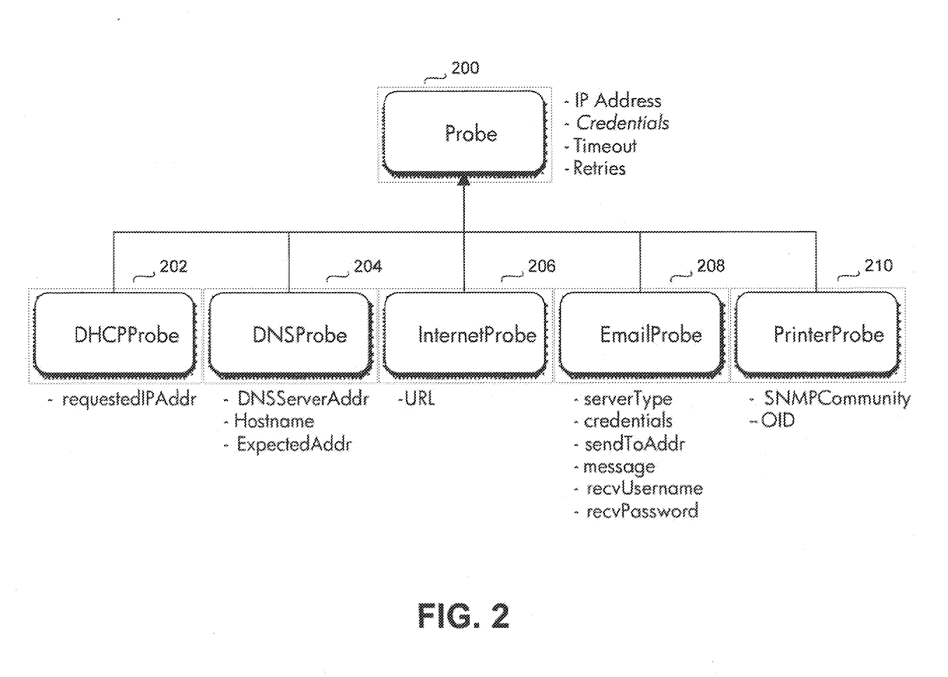

FIG. 2 depicts an example probe class hierarchy that may be employed by the monitoring module. As can be seen in FIG. 2, probe 200 utilizes an IP address parameter representing the internet protocol (IP) address of the network services device hosting the network service to be monitored, a credentials parameter representing credentials of the device requesting monitoring, for example, a certificate, a username/password, etc.; a timeout parameter representing a time allocated to obtain the measurements before a timeout is indicated and a retries parameter representing if and/or how many retries are permitted.

As shown in FIG. 2, there are five different probes that may be utilized by the monitoring module. The probes may utilize one or more parameters that facilitate monitoring of services at network services device 106.

DHCPProbe 202 may utilize a requestedIPAddr parameter representing the IP address of the requested DHCP device.

DNSProbe 204 may utilize a DNSServerAddr parameter representing the address of the DNS server on the network; a Hostname parameter representing the name of the host, and an ExpectedAddr parameter representing the expected IP address of the host specified in the request.

InternetProbe 206 may utilize a URL parameter representing the uniform resource locator (URL) of the internet site to be monitored.

EmailProbe 208 may utilize a serverType parameter representing the type of server, a credentials parameter representing credentials of the email server; sendToAddr parameter representing email address to monitor, a message parameter representing a message, a recvUsername parameter representing a username of an email address at the email server, and a recvPassword representing the password of the email account at the email server.

PrinterProbe 210 may utilize a simple network management protocol (SNMP) Community parameter representing identification of the SNMP community to which the printer belongs, and an OID parameter representing an object identifier of the printer to be monitored.

By utilizing these parameters, the monitoring module may monitor availability, response time, etc., of the services provide at network services device 106.

It may be appreciated that additional probes may be utilized for monitoring additional network services.

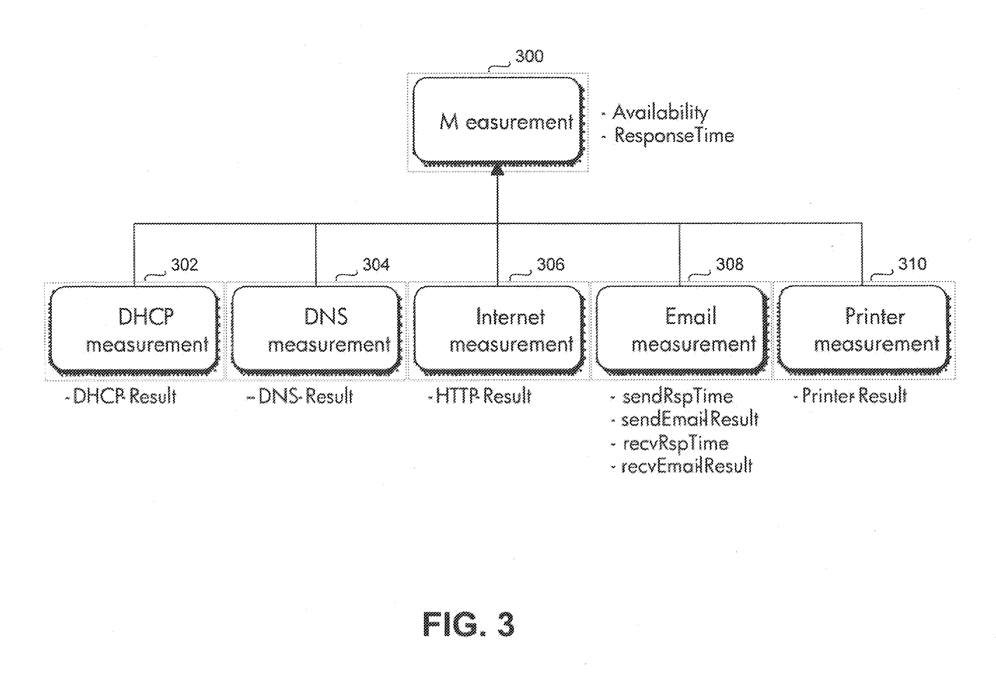

FIG. 3 depicts an example measurement hierarchy representing the measurements the monitoring module may obtain. As shown in FIG. 3, measurement 300 may obtain availability and response time. DHCP measurement 302 may obtain a DHCP result representing the measurements from the DHCP probe. DNS measurement 304 may obtain a DNS result representing the measurements from the DNS probe. Internet measurement 306 may obtain a HTTP result representing the measurements from the Internet probe. Email measurement 308 may obtain sendrspTime, sendEmailResult, recvRspTime and recvEmailResult representing measurements from the Email probe; and printer measurement 310 may obtain PrinterResult representing the measurements from the Printer probe. In each case, the service monitoring probe may determine if the service was available, did it return the expected response, what was the response time, etc.

### Collection Module

After the monitoring module obtains monitoring information, i.e., availability, response time, etc., from the network services at network services device 106, the measurements received for each probe attempt may be stored by the collection module 112. A predetermined number of the most recent probe results may be stored, for example, in the following manner, in a round-robin fashion, without requiring too much memory on the probe itself.

| | c-2 | c-1 | current | c-5 | c-4 | c-3 |
|---|---|---|---|---|---|---|
| DHCP | A: | A: | A: | A: | A: | A: |
| 10.10.10.60 | RT: | RT: | RT: | RT: | RT: | RT: |
| DNS | | | | | | |
| 10.10.10.50 | A: | A: | A: | A: | A: | A: |
| 10.10.10.51 | RT: | RT: | RT: | RT: | RT: | RT: |
| Internet | | | | | | |
| www.google.com | A: | A: | A: | A: | A: | A: |
| www.hp.com/procurve | RT: | RT: | RT: | RT: | RT: | RT: |
| Mail | | | | | | |
| 10.220.151.3 | A: | A: | A: | A: | A: | A: |
| 10.220.151.4 | RT: | RT: | RT: | RT: | RT: | RT: |
| Printers | | | | | | |
| 10.10.0.67 | A: | A: | A: | A: | A: | A: |
| 10.10.0.125 | RT: | RT: | RT: | RT: | RT: | RT: |

In the example above, there are six measurements stored for each probe. Within each measurement cell, two values may be stored: Availability (A) and Response Time (RT). This data alone may only reflect a predetermined number of results, for example, the last six results, of the probe. The stored predetermined number of results may be sufficient to determine whether a particular service was available, unavailable, intermittently available, and whether the response time was currently normal or poor.

The results captured by the probe may to be temporarily stored and delivered or retrieved by administrative server 108 or end user device 102. Administrative server 108 and/or end user device 102 may store the information collected from the monitoring module 110 and perform analysis on the data and generate reports related to the network services. Alternatively, the edge network device may perform analysis on the stored information and transmit the analysis results to end user device 102, administrative server 108, etc.

### Transmission Module

The transmission module facilitates transmission of the stored monitored information to a remote network device, for example, end user device 102, administrative server 108, a remote storage device, etc., or any other device within the network. One alternative for the information to be transmitted may be for the administrative server 108 and/or the end user device 102 to periodically poll the edge network device 104 for the stored information. The polling intervals may be coordinated with the probing intervals. Another alternative for the information to be transmitted may be for the transmission module to access the stored monitored information and forward the information to the end user device 102 and/or the administrative server 108 via, for example, an SNMP trap, using a web service, etc.

### Configuration Module

The configuration module may facilitate entry and receipt of the parameters used to monitor network services at network services device 106. The configuration module may generate a graphical user interface that may be displayed at, for example, end user device 102 and/or administrative server 108. The graphical user interface may include fields to enable selection of a probe and entry of parameters used to facilitate monitoring of the network service associated with the probe. The parameters associated with each probe are noted above. The information that is received via the graphical user interface may be stored and utilized by the monitoring module.

Additional field may be provided in the graphical user interface, for example, the start and stop date and/or time of the probe, the polling interval of the probe, the number of probe results to be stored, what results are to be captured, for example, availability, response time, etc., identification of the device where the results are to be sent, etc.

The information that is received through the graphical user interface may be stored in primary or secondary memory. The monitoring module may utilize the information received through the graphical user interface to facilitate the monitoring process.

### Monitoring Process

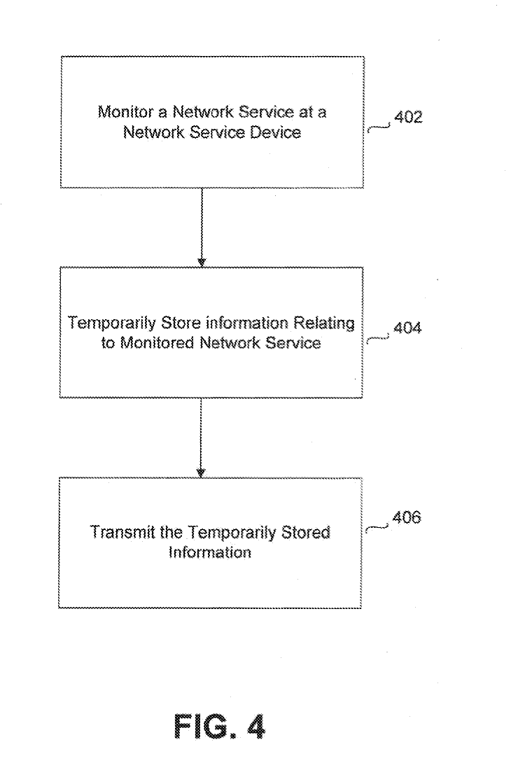

FIG. 4 depicts an example flow diagram of the steps monitoring a network service in accordance with an example embodiment. As can be seen in FIG. 4, a network service provided at the network services device 106 may be monitored (402). Monitoring may be performed by a probe discussed above. Information related to the monitored network service may be temporarily stored (404). Information related to the monitored network service may include availability, response time, etc. The temporarily stored information may be transmitted (406), for example, to end user device 102, administrative server 108, remote storage device, etc.

By providing for the edge network device to monitor network services, information related to the monitoring may be stored for a period of time, and then transmitted to a remote network device for viewing, processing, analyzing, reporting, administering, long-term storage, etc.

Monitoring of the network service may alternatively include receiving configuration information regarding a network service to be monitored. The configuration information may include the network service to be monitored and one or more parameters to facilitate monitoring of the network service. The configuration information may be received from the end user device 102, the administrative server 108, etc. The configuration information may be used to facilitate monitoring of the network services at network services device 106.

I claim:

1. A method, comprising:
monitoring, at an edge network device, a network service at a network service device remote from the edge network device;
temporarily storing, at the edge network device, information relating to the monitored network service; and
transmitting the temporarily stored information to a remote network device.

2. The method of claim 1, further comprising:
receiving configuration information from the remote network device, the configuration including information identifying the network service to be monitored and a parameter to facilitate monitoring the network service.

3. The method of claim 2, wherein the remote network device is an administrative network device.

4. The method of claim 2, wherein the remote network device is an end user device.

5. The method of claim 1, wherein the information is stored for a predetermined amount of time before transmitting the information to the remote network device.

6. The method of claim 1, wherein the network service is one of dynamic host configuration protocol (DHCP) server, domain name system (DNS), Internet, electronic mail server and printer server.

7. An edge network device, comprising:
a monitoring module at the edge network device to monitor a network service at a network service device;
storage at the edge network device to store information relating to the monitored network service; and
a communications module at the edge network device to transmit the stored information related to the monitored network service.

8. The edge network device of claim 7, further comprising:
a configuration module at the edge network device to configure the network service to be monitored by the monitoring module.

9. The edge network device of claim 8, wherein the configuration module includes an interface to receive a parameter and to facilitate storage of the parameter for use by the monitoring module to monitor the network service.

10. The edge network device of claim 7, wherein the network service is one of dynamic host configuration protocol (DHCP) server, domain name system (DNS), Internet, electronic mail server and printer server.

11. A non-transitory computer-readable medium, storing a set of instructions, executable by a processor, to perform a method to:
access at an edge network device, a parameter relating to a network service to be monitored;
monitor, utilizing a probe, a network service provided at a network service device remote from the edge network device;
temporarily store, at the edge network device, information relating to the monitored network service; and
transmit the temporarily stored information to a remote network device.

12. The non-transitory computer-readable medium of claim 11, the method further to:
receive, from an end user device, the parameter relating to the network service to be monitored.

13. The non-transitory computer-readable medium of claim 11, the method further to:
receive, from an administrative server device, the parameter relating to the network service to be monitored.

14. The non-transitory computer-readable medium of claim 11, wherein the network service is one of dynamic host configuration protocol (DHCP) server, domain name system (DNS), Internet, electronic mail server and printer server.

15. The non-transitory computer-readable medium of claim 11, wherein the temporarily stored information is transmitted to an end user device.

16. The non-transitory computer-readable medium of claim 11, the method further to:
provide an interface to enable entry of a parameter related to monitoring of the network service.
